(19) United States
(12) Patent Application Publication
(10) Pub. No.: US 2014/0358400 A1
(43) Pub. Date: Dec. 4, 2014

(54) SYSTEM AND METHOD FOR CONTROLLING A POWERTRAIN SYSTEM TO PERFORM EXHAUST BRAKING

(71) Applicant: GM Global Technology Operations LLC, Detroit, MI (US)

(72) Inventors: Christopher E. Whitney, COMMERCE, MI (US); CHAD E. MARLETT, PLYMOUTH, MI (US); LUCA SCAVONE, MONCALIERI (IT); KELLY T. JOZEFOWICZ, HIGHLAND, MI (US); TRENTON W. HAINES, NOVI, MI (US); SIMONE BARBERO, TORINO (IT)

(73) Assignee: GM Global Technology Operations LLC, Detroit, MI (US)

(21) Appl. No.: 13/904,177

(22) Filed: May 29, 2013

(51) Int. Cl. B60W 10/198; B60W 10/06

(52) U.S. Cl. CPC B60W 10/198; B60W 10/06
USPC 701/102

(57) ABSTRACT

A system according to the principles of the present disclosure includes an exhaust braking enabling module, a driver torque module, and an engine actuator control module. The exhaust braking enabling module selectively enables exhaust braking based on driver input and independent of an accelerator pedal position. The driver torque module selectively determines a driver torque request based on a powertrain braking torque capacity when exhaust braking is enabled. The engine actuator control module controls fuel delivery to cylinders of an engine and a vane position of a turbocharger based on the driver torque request.

### FIELD

The present disclosure relates to systems and methods for controlling a powertrain system to perform exhaust braking.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Internal combustion engines combust an air and fuel mixture within cylinders to drive pistons, which produces drive torque. Air flow into the engine is regulated via a throttle. More specifically, the throttle adjusts throttle area, which increases or decreases air flow into the engine. As the throttle area increases, the air flow into the engine increases. A fuel control system adjusts the rate that fuel is injected to provide a desired air/fuel mixture to the cylinders and/or to achieve a desired torque output. Increasing the amount of air and fuel provided to the cylinders increases the torque output of the engine.

In spark-ignition engines, spark initiates combustion of an air/fuel mixture provided to the cylinders. In compression-ignition engines, compression in the cylinders combusts the air/fuel mixture provided to the cylinders. Spark timing and air flow may be the primary mechanisms for adjusting the torque output of spark-ignition engines, while fuel flow may be the primary mechanism for adjusting the torque output of compression-ignition engines.

### SUMMARY

A system according to the principles of the present disclosure includes an exhaust braking enabling module, a driver torque module, and an engine actuator control module. The exhaust braking enabling module selectively enables exhaust braking based on driver input and independent of an accelerator pedal position. The driver torque module selectively determines a driver torque request based on a powertrain braking torque capacity when exhaust braking is enabled. The engine actuator control module controls fuel delivery to cylinders of an engine and a vane position of a turbocharger based on the driver torque request.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example engine system according to the principles of the present disclosure;

FIG. 2 is a functional block diagram of an example control system according to the principles of the present disclosure;

FIGS. 3 and 4 are graphs illustrating example torque control curves according to the principles of the present disclosure; and

FIGS. 5 and 6 are flowcharts illustrating an example control method according to the principles of the present disclosure.

In the drawings, reference numbers may be reused to identify similar and/or identical elements.

### DETAILED DESCRIPTION

Exhaust braking may be performed by cutting off fuel delivery to cylinders of an engine and closing off an exhaust path from the engine, causing exhaust gases to be compressed in an exhaust manifold of the engine and in cylinders of the engine. If the engine is equipped with a variable geometry turbocharger, the exhaust path from the engine may be closed off by adjusting the position of vanes in the turbocharger. Since the exhaust gas is being compressed and fuel delivery to the cylinders is cutoff, the engine produces negative torque, slowing down the vehicle. The amount of negative torque generated by the engine is directly proportional to the back pressure of the engine. In addition to or instead of closing off the exhaust path, exhaust braking may be performed using other methods of increasing the pumping losses of the engine such as closing a throttle and/or disabling opening of intake valves and/or exhaust valves of an engine.

Typically, exhaust braking is only performed when a driver's foot is removed from an accelerator pedal. In contrast, a system and method according to the present disclosure may perform exhaust braking when a driver's foot is on an accelerator pedal. In one example, the system and method may determine whether a pedal torque request corresponding to an accelerator pedal position is greater than a first torque required to maintain vehicle speed at a constant speed on a flat grade. If the pedal torque request is less than the first torque, the system and method may control the torque output of the engine based on a blend between the first torque and a second torque used to control the engine when the driver's foot is off the accelerator pedal. If the pedal torque request is less than the first torque, the system and method may control the torque output of the engine based on the pedal torque request.

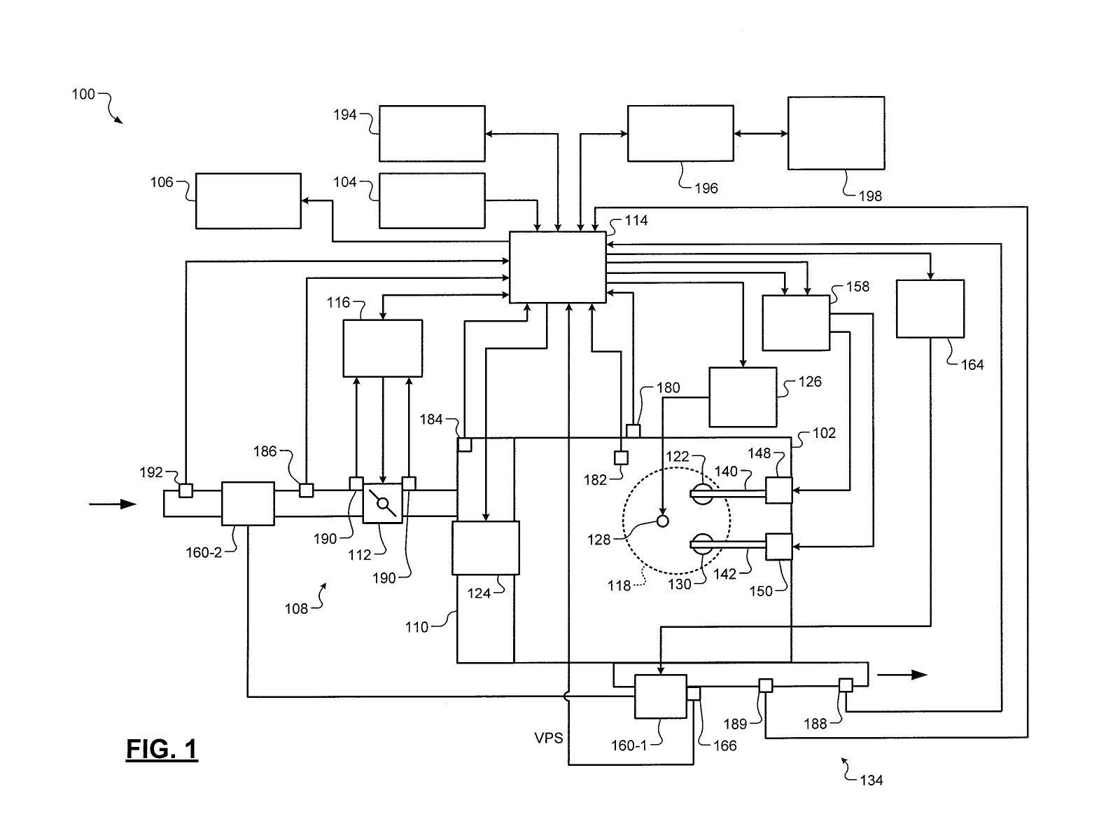

Referring now to FIG. 1, an engine system 100 includes an engine 102 that combusts an air/fuel mixture to produce drive torque for a vehicle. The amount of drive torque produced by the engine 102 is based on driver input from a driver input module 104. The driver input may be based on a position of an accelerator pedal. The driver input may also be based on a cruise control system, which may be an adaptive cruise control system that varies vehicle speed to maintain a predetermined following distance. In addition, exhaust braking may be enabled or disabled based on the driver input. An exhaust braking indicator 106 may indicate whether exhaust braking is enabled or disabled using, for example, a visual message (e.g., text), an audible message (e.g., chime), and/or a tactile message (e.g., vibration).

Air is drawn into the engine 102 through an intake system 108. The intake system 108 includes an intake manifold 110 and a throttle valve 112. For example only, the throttle valve 112 may include a butterfly valve having a rotatable blade. An engine control module (ECM) 114 controls a throttle actuator module 116, which regulates opening of the throttle valve 112 to control the amount of air drawn into the intake manifold 110.

Air from the intake manifold 110 is drawn into cylinders of the engine 102. While the engine 102 may include multiple cylinders, for illustration purposes a single representative cylinder 118 is shown. For example only, the engine 102 may include 2, 3, 4, 5, 6, 8, 10, and/or 12 cylinders. The ECM 114 may deactivate some of the cylinders, which may improve fuel economy under certain engine operating conditions.

The engine 102 may operate using a four-stroke cycle. The four strokes, described below, are named the intake stroke, the compression stroke, the combustion stroke, and the exhaust stroke. During each revolution of a crankshaft (not shown), two of the four strokes occur within the cylinder 118. Therefore, two crankshaft revolutions are necessary for the cylinder 118 to experience all four of the strokes.

During the intake stroke, air from the intake manifold 110 is drawn into the cylinder 118 through an intake valve 122. The ECM 114 controls a fuel actuator module 124, which regulates fuel injection to achieve a desired air/fuel ratio. Fuel may be injected into the intake manifold 110 at a central location or at multiple locations, such as near the intake valve 122 of each of the cylinders. In various implementations, fuel may be injected directly into the cylinders or into mixing chambers associated with the cylinders. The fuel actuator module 124 may halt injection of fuel to cylinders that are deactivated.

The injected fuel mixes with air and creates an air/fuel mixture in the cylinder 118. During the compression stroke, a piston (not shown) within the cylinder 118 compresses the air/fuel mixture. The engine 102 may be a compression-ignition engine, in which case only air may be compressed within the cylinder 118 and, when fuel is mixed with the air, compression in the cylinder 118 ignites the air/fuel mixture. In addition, fuel may not be injected into the intake manifold 110 if the engine 102 is a compression-ignition engine. Alternatively, the engine 102 may be a spark-ignition engine, in which case a spark actuator module 126 energizes a spark plug 128 in the cylinder 118 based on a signal from the ECM 114, which ignites the air/fuel mixture. The timing of the spark may be specified relative to the time when the piston is at its topmost position, referred to as top dead center (TDC).

The spark actuator module 126 may be controlled by a timing signal specifying how far before or after TDC to generate the spark. Because piston position is directly related to crankshaft rotation, operation of the spark actuator module 126 may be synchronized with crankshaft angle. In various implementations, the spark actuator module 126 may halt provision of spark to deactivated cylinders.

Generating the spark may be referred to as a firing event. The spark actuator module 126 may have the ability to vary the timing of the spark for each firing event. The spark actuator module 126 may even be capable of varying the spark timing for a next firing event when the spark timing signal is changed between a last firing event and the next firing event. If the engine 102 includes multiple cylinders, the spark actuator module 126 may vary the spark timing relative to TDC by the same amount for all of the cylinders in the engine 102.

During the combustion stroke, the combustion of the air/fuel mixture drives the piston down, thereby driving the crankshaft. The combustion stroke may be defined as the time between the piston reaching TDC and the time at which the piston returns to bottom dead center (BDC). During the exhaust stroke, the piston begins moving up from BDC and expels the byproducts of combustion through an exhaust valve 130. The byproducts of combustion are exhausted from the vehicle via an exhaust system 134.

The intake valve 122 may be controlled by an intake camshaft 140, while the exhaust valve 130 may be controlled by an exhaust camshaft 142. In various implementations, multiple intake camshafts (including the intake camshaft 140) may control multiple intake valves (including the intake valve 122) for the cylinder 118 and/or may control the intake valves (including the intake valve 122) of multiple banks of cylinders (including the cylinder 118). Similarly, multiple exhaust camshafts (including the exhaust camshaft 142) may control multiple exhaust valves for the cylinder 118 and/or may control exhaust valves (including the exhaust valve 130) for multiple banks of cylinders (including the cylinder 118).

The time at which the intake valve 122 is opened may be varied with respect to piston TDC by an intake cam phaser 148. The time at which the exhaust valve 130 is opened may be varied with respect to piston TDC by an exhaust cam phaser 150. A valve actuator module 158 may control the intake and exhaust cam phasers 148, 150 based on signals from the ECM 114. When implemented, variable valve lift may also be controlled by the valve actuator module 158.

The valve actuator module 158 may deactivate the cylinder 118 by disabling opening of the intake valve 122 and/or the exhaust valve 130. For example only, the valve actuator module 158 may disable opening of the intake valve 122 by decoupling the intake valve 122 from the intake cam phaser 148. Similarly, the valve actuator module 158 may disable opening of the exhaust valve 130 by decoupling the exhaust valve 130 from the exhaust cam phaser 150. In various implementations, the valve actuator module 158 may control the intake valve 122 and the exhaust valve 130 using devices other than camshafts, such as electromagnetic or electrohydraulic actuators.

The engine system 100 may include a boost device that provides pressurized air to the intake manifold 110. For example, FIG. 1 shows a turbocharger including a hot turbine 160-1 that is powered by hot exhaust gases flowing through the exhaust system 134. The turbocharger also includes a cold air compressor 160-2, driven by the turbine 160-1, which compresses air leading into the throttle valve 112. In various implementations, a supercharger (not shown), driven by the crankshaft, may compress air from the throttle valve 112 and deliver the compressed air to the intake manifold 110.

The turbocharger may be a variable geometry turbocharger (VGT). The ECM 114 may control the turbocharger via a VGT actuator module 164. The VGT actuator module 164 may modulate the boost of the turbocharger by controlling the position of one or more vanes in the turbocharger. The position of the vanes in the turbocharger may be measured using a vane position (VPS) sensor 166. In various implementations, multiple turbochargers may be controlled by the VGT actuator module 164.

An intercooler (not shown) may dissipate some of the heat contained in the compressed air charge, which is generated as the air is compressed. The compressed air charge may also have absorbed heat from components of the exhaust system 134. Although shown separated for purposes of illustration, the turbine 160-1 and the compressor 160-2 may be attached to each other, placing intake air in close proximity to hot exhaust.

The engine system 100 may measure the position of the crankshaft using a crankshaft position (CKP) sensor 180. The temperature of the engine coolant may be measured using an engine coolant temperature (ECT) sensor 182. The ECT sensor 182 may be located within the engine 102 or at other locations where the coolant is circulated, such as a radiator (not shown).

The pressure within the intake manifold 110 may be measured using a manifold absolute pressure (MAP) sensor 184. In various implementations, engine vacuum, which is the difference between ambient air pressure and the pressure within the intake manifold 110, may be measured. The mass flow rate of air flowing into the intake manifold 110 may be measured using a mass air flow (MAF) sensor 186. In various implementations, the MAF sensor 186 may be located in a housing that also includes the throttle valve 112.

The pressure within the exhaust system 134 may be measured using an exhaust pressure (EXP) sensor 188. In various implementations, the EXP sensor 188 may include multiple sensors that measure pressure upstream and downstream from a particulate filter (not shown) included in the exhaust system 134. The temperature within the exhaust system 134 may be measured using an exhaust temperature (EXT) sensor 189. The EXP sensor 188 and/or the EXT sensor 189 may be located downstream from the turbocharger's turbine 160-1, as shown.

The throttle actuator module 116 may monitor the position of the throttle valve 112 using one or more throttle position (TPS) sensors 190. The ambient temperature of air being drawn into the engine 102 may be measured using an intake air temperature (IAT) sensor 192. The ECM 114 may use signals from the sensors to make control decisions for the engine system 100.

The ECM 114 may communicate with a transmission control module (TCM) 194 to coordinate shifting gears in a transmission (not shown). For example, the ECM 114 may reduce engine torque during a gear shift. The ECM 114 may communicate with a hybrid control module (HCM) 196 to coordinate operation of the engine 102 and an electric motor 198. The electric motor 198 may also function as a generator, and may be used to produce electrical energy for use by a vehicle electrical system and/or for storage in a battery. In various implementations, various functions of the ECM 114, the TCM 194, and the HCM 196 may be integrated into one or more modules.

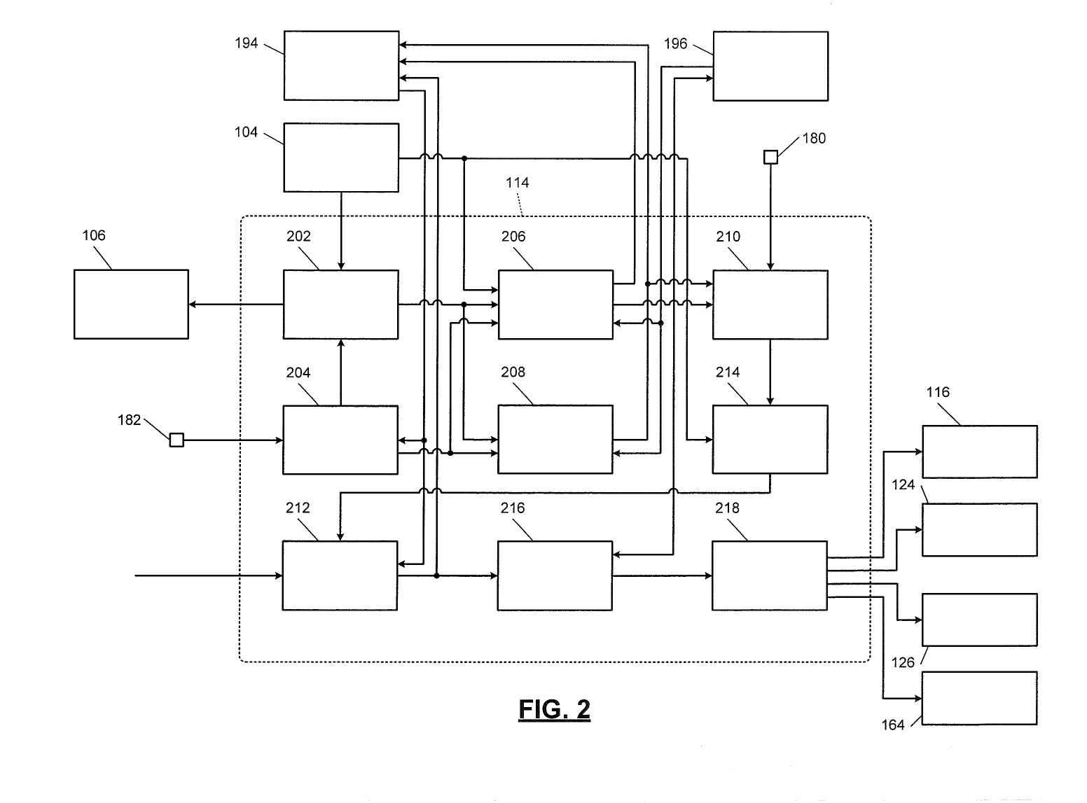

Referring now to FIG. 2, an example implementation of the ECM 114 includes an exhaust braking enabling module 202. The exhaust braking enabling module 202 enables and disables exhaust braking based on the driver input from the driver input module 104 and/or independent of the accelerator pedal position. For example, the exhaust braking enabling module 202 may enable or disable exhaust braking when a driver presses a button. The exhaust braking enabling module 202 outputs a signal indicating whether exhaust braking is enabled.

An exhaust braking availability module 204 determines whether exhaust braking is available based on, for example, transmission state, engine coolant temperature, and/or detection of faults in the transmission or exhaust braking hardware. The exhaust braking availability module 204 may determine that exhaust braking is not available when the transmission is not in drive (e.g., the transmission is in park or neutral), indicating an inability to transmit torque from the engine 102 to wheels (not shown). The exhaust braking availability module 204 may determine that exhaust braking is not available when the engine coolant temperature is outside of a predetermined temperate range (e.g., greater than 30 degrees Celsius (° C.)). The predetermined temperature range may be selected to ensure that the temperature of oil in the engine 102 is sufficient for lubrication and, if the turbocharger is oil actuated, for controlling the turbocharger.

The exhaust braking availability module 204 may determine that exhaust braking is not available when a fault is detected in the transmission or in the exhaust braking hardware. The exhaust braking hardware may include the turbocharger, the VPS sensor 166, the EXP sensor 188, the EXT sensor 189, and/or other hardware components used to effectuate exhaust braking. The exhaust braking availability module 204 may determine the transmission state and/or whether a fault is detected in the transmission based on input from the TCM 194.

A fault may be detected in the transmission when the output of a transmission gear selector position sensor (not shown) is outside of a predetermined range. A fault may be detected in the transmission when the output of a transmission input shaft speed (TISS) sensor (not shown) is outside of a predetermined range. A fault may be detected in the transmission when the output of a transmission output shaft speed (TOSS) sensor (not shown) is outside of a predetermined range. A fault may be detected in the transmission when the output of a transmission fluid pressure sensor (not shown) is outside of a predetermined range.

A fault may be detected in the exhaust braking hardware when a difference between a desired vane position and the vane position measured by the VPS sensor 166 is greater than a predetermined value. A fault may be detected in the exhaust braking hardware when the output of the EXT sensor 189 is outside of a predetermined range and/or outside of an expected range that is determined based on various other engine operating conditions. A fault may be detected in the exhaust braking hardware when a difference between the exhaust pressures measured upstream and downstream from the particulate filter is greater than a predetermined difference.

The exhaust braking availability module 204 outputs a signal indicating whether exhaust braking is available. The exhaust braking enabling module 202 may not enable exhaust braking when exhaust braking is not available. In addition, the exhaust braking enabling module 202 may activate the exhaust braking indicator 106 when exhaust braking is not available. In turn, the exhaust braking indicator 106 may provide feedback to the driver indicating that exhaust braking is not available.

A powertrain braking module 206 arbitrates between various powertrain braking torque requests and outputs a powertrain braking torque request based on the arbitration. The powertrain braking torque requests may include a cruise control torque request, an exhaust braking torque request, and/or a grade braking torque request. The driver input module 104 may set the cruise control torque request to a negative value when a measured vehicle speed is greater than a set speed by a predetermined value. The exhaust braking enabling module 202 may generate the exhaust braking torque request when the driver requests exhaust braking. The grade braking torque request may be generated when the vehicle is accelerating while travelling on a downhill grade and the driver is pressing the accelerator pedal.

The powertrain braking module 206 may inform other modules in the ECM 114, the TCM 194, and/or the HCM 196 when exhaust braking is enabled and available. In addition, the powertrain braking module 206 may request a decrease in a zero pedal torque. The zero pedal torque is requested when the driver removes their foot from the accelerator pedal or at low accelerator pedal values, such as when the vehicle is idling or coasting down from a higher speed. The powertrain braking module 206 may inform the TCM 194 that an alternate shift schedule is desired for powertrain braking when exhaust braking is enabled and available.

A braking torque capacity module 208 determines a powertrain braking torque capacity. The powertrain braking torque capacity may include the amount of negative brake torque that the engine 102 is capable of producing when fueling to cylinders of the engine 102 is cutoff and the vane position of the turbocharger is adjusted to yield maximum allowable exhaust braking. The amount of negative brake torque produced by the engine 102 may be based on friction within the engine 102, normal pumping losses when exhaust braking is disabled, and/or additional pumping losses when exhaust braking is enabled. The braking torque that the engine 102 is capable of producing due to the additional pumping losses when exhaust braking is enabled may be referred to as exhaust braking torque capacity. The exhaust braking torque capacity may be limited to prevent damage to the exhaust braking hardware. For example, if the pressure within an exhaust manifold is greater than a first pressure, the exhaust manifold or the turbocharger may be damaged. Thus, the exhaust braking torque capacity may be limited to maintain the pressure within the exhaust manifold less than the first pressure. The powertrain braking torque capacity may also include the amount of braking torque that the electric motor 198 is capable of producing, which may be received from the HCM 196. The braking torque capacity module 208 outputs the powertrain braking torque capacity.

A zero pedal torque module 210 determines the zero pedal torque. The zero pedal torque module 210 may determine the zero pedal torque based on one or more relationships between the zero pedal torque and the vehicle speed or engine speed. The relationships may be predetermined and/or embodied in a curve, a lookup table, and/or an equation. The zero pedal torque module 210 may select one of the relationships based on the powertrain braking torque capacity and/or the powertrain braking torque request, and determine the zero pedal torque based on the selected one of the relationships. When selecting one of the relationships, the zero pedal torque module 210 may ensure that the resulting zero pedal torque is within the powertrain torque capacity. The zero pedal torque determined based on the selected one of the relationships may be a braking torque that is less than or equal to the powertrain braking torque capacity. The braking torque may be less than the powertrain torque capacity when, for example, the amount of deceleration provided by operating at the powertrain braking torque capacity is greater than desired. Similarly, the maximum allowable exhaust braking may be less than a maximum achievable exhaust braking when adjusting the vane position to yield the maximum achievable exhaust braking provides an amount of deceleration that is greater than desired. The engine speed may be determined based on input from the CKP sensor 180. The vehicle speed may be determined based on input from the TISS sensor, the TOSS sensor, and/or a wheel speed sensor (not shown).

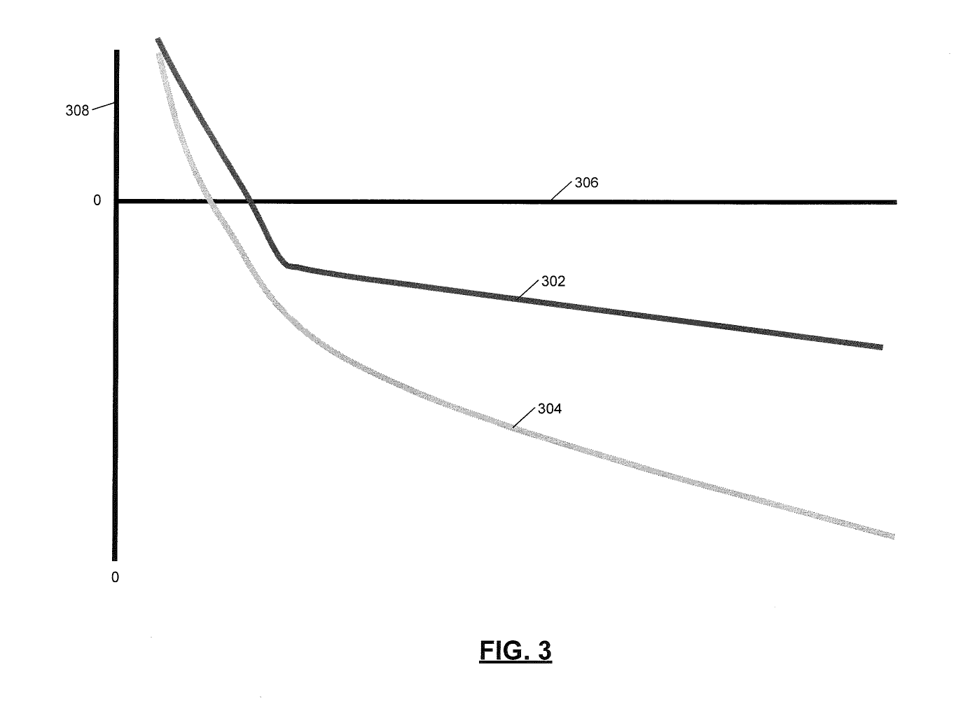

Referring briefly to FIG. 3, examples of zero pedal torque curves corresponding to when exhaust braking is disabled and enabled are illustrated at 302 and 304, respectively. The torque curves 302, 304 are plotted with respect to an x-axis 306 that represents engine speed in revolutions per minute (RPM) and a y-axis 308 that represents engine torque in Newton-meters (Nm). The torque curves 302, 304 specify more braking torque as the engine speed increases. The torque curves 302, 304 adjust torque to a neutral level (e.g., 0 Nm) as the engine speed decreases to avoid an engine stall and to provide stable control from large negative values to more neutral values. The torque curves 302, 304 may be adjusted based on the powertrain braking torque capacity.

Referring again to FIG. 2, the TCM 194 may adjust a transmission shift schedule to the alternate shift schedule when exhaust braking is enabled and available. The alternate shift schedule may increase engine speed to achieve a higher level of exhaust braking by forcing more air into the turbocharger. When cruise control is disabled, the TCM 194 may downshift the transmission when the engine 102 is producing a maximum braking torque and the vehicle is accelerating. The engine 102 may produce the maximum braking torque when fueling to the engine 102 is cutoff and the vane position of the turbocharger is adjusted to yield maximum allowable exhaust braking.

The TCM 194 may request an upshift when the vehicle is decelerating or traveling at a relatively constant speed and the current axle torque can be achieved in a higher gear (e.g., using more exhaust braking). The TCM 194 may receive an axle torque request from a torque arbitration module 212 and use the axle torque request received as an approximation of the current axle torque. The TCM 194 may determine whether the current axle torque can be achieved in a higher gear based on a gear ratio of the higher gear and the powertrain braking torque capacity. For example, the TCM 194 may predict the powertrain braking torque capacity when the transmission is upshifted based on the gear ratio of the higher gear, the gear ratio of the current gear, and or the current powertrain braking torque capacity. The TCM 194 may then determine whether the current axle torque is within the predicted braking torque capacity.

When cruise control is enabled, the TCM 194 may downshift the transmission when the engine 102 is producing the maximum braking torque and the vehicle speed is greater than a set speed by a predetermined amount. The TCM 194 may request an upshift when the vehicle speed is within a predetermined range of the set speed and the current axle torque can be achieved in a higher gear (e.g., using more exhaust braking).

A driver torque module 214 determines a pedal torque request based on the accelerator pedal position and determines a driver torque request based on the zero pedal torque and/or the pedal torque request. If the driver's foot is off the accelerator pedal (e.g., the pedal torque request is less than a predetermined torque), the driver torque module 214 may set the driver torque request to the zero pedal torque. If the driver's foot is on the accelerator pedal and the pedal torque request is greater than or equal to road load, the driver torque module 214 may set the driver torque request equal to the pedal torque request. Thus, the driver torque module 214 may not adjust the driver torque request based on the zero pedal torque when the pedal torque request is greater than or equal to road load while exhaust braking is enabled. Road load is an amount of torque required to maintain the vehicle speed at a constant speed in nominal conditions (e.g., when the vehicle is travelling on a flat grade).

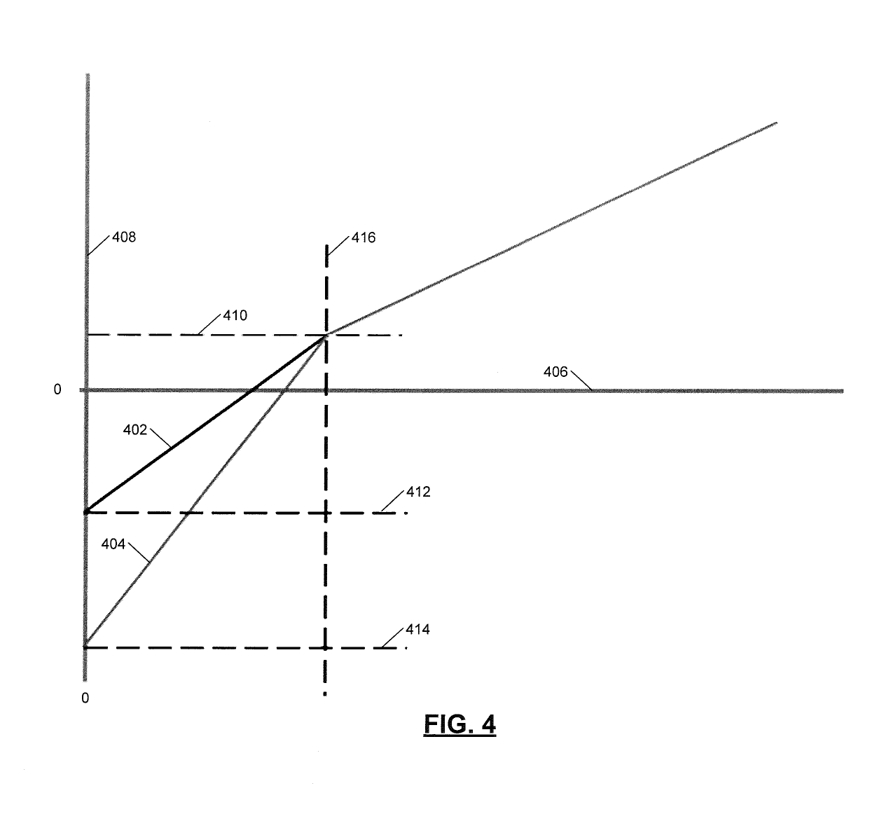

If the driver's foot is on the accelerator pedal and the pedal torque request is less than road load, the driver torque module 214 may determine the driver torque request based on pedal position and a blend between the road load and the zero pedal torque. Referring briefly to FIG. 4, example torque curves 402, 404 that may be used to determine the driver torque request are plotted with respect to an x-axis 406 that represents pedal position and a y-axis 408 that represents engine torque in Nm. The torque curve 402 is determined based on a blend of a road load 410 and a zero pedal torque 412 with exhaust braking disabled. The torque curve 404 is determined based on a blend of the road load 410 and a zero pedal torque 414 with exhaust braking enabled. The torque curves 402, 404 may be determined by interpolating between the road load 410 and the respective zero pedal torques 412, 414 at various pedal positions between a zero pedal position along the y-axis 408 and a road load pedal position 416.

Referring again to FIG. 2, the torque arbitration module 212 arbitrates between the driver torque request and other axle torque requests and outputs an axle torque request based on the arbitration. Axle torque (torque at the wheels) may be produced by various sources including the engine 102 and/or the electric motor 198. Axle torque requests may include a torque increase requested by a vehicle stability control system to prevent wheel slip when the coefficient of friction of the road surface is insufficient to support the amount of negative axle torque generated via exhaust braking. The torque arbitration module 212 may output an axle torque request that is greater than the drive torque request when the other axle torque requests include torque increases.

In various implementations, instead of outputting an axle torque request based on the arbitration, the torque arbitration module 212 may convert the axle torque request into a crankshaft torque request based on the ratio through the driveline from the crankshaft to the axle. The torque arbitration module 212 may then arbitrate between the converted torque request and other crankshaft torque requests, and output a crankshaft torque request based on the arbitration. Crankshaft torque (torque at the crankshaft) may be produced by various sources including the engine 102 and/or the electric motor 198. Crankshaft torque requests may include a torque increase requested by the TCM 194 to improve the feel of a transmission downshift.

A torque control module 216 determines a motor torque request and an engine torque request based on the torque request output by the torque arbitration module 212. If the torque arbitration module 212 outputs an axle torque request, the torque control module 216 may convert the axle torque request into a crankshaft torque request based on the ratio through the driveline from the crankshaft to the axle. The torque control module 216 may then determine the motor torque request and the engine torque request based on the converted torque request. If the torque arbitration module 212 outputs a crankshaft torque request, the torque control module 216 may determine the motor torque request and the engine torque request based on the crankshaft torque request without performing a conversion.

Thus, the torque control module 216 determines the motor torque request and the engine torque request based on crankshaft torque request, which may be received from the torque arbitration module 212 or determined based on an axle torque request received therefrom. If the crankshaft torque request is negative and the absolute value of the crankshaft torque request is less than the maximum braking torque, the torque control module 216 may adjust the motor torque request to zero and adjust the engine torque request to the crankshaft torque request. Alternatively, if torque is requested to regenerate a battery, the torque control module 216 may adjust the motor torque request to the regenerative torque request and adjust the engine torque request to a difference between the crankshaft torque request and the regenerative torque request. If the crankshaft torque request is negative and the absolute value of the crankshaft torque request is greater than the maximum braking torque, the torque control module 216 may adjust the engine torque request to the maximum braking torque. In addition, the torque control module 216 may adjust the motor torque request to a difference between the crankshaft torque request and the maximum braking torque.

The HCM 196 may control the electric motor 198 based on the motor torque request from the torque control module 216. An engine actuator control module 218 controls the engine 102 and/or the turbocharger based on the engine torque request. The engine actuator control module 218 may determine desired throttle area, desired fueling rate, desired spark timing, and desired vane position based on the engine torque request. The engine actuator control module 218 may output the desired throttle area, the desired fueling rate, and the desired spark timing to the throttle actuator module 116, the fuel actuator module 124, and the spark actuator module 126, respectively. In addition, the engine actuator control module 218 may output the desired vane position to the VGT actuator module 164.

The engine actuator control module 218 may control the fueling rate and the vane position in a way that satisfies the engine torque request and prevents the turbocharger from trapping exhaust flow and combustion fuel in the exhaust system 134. For example, the engine actuator control module 218 may cut off fuel flow in the engine 102 when exhaust braking is enabled. In addition, the engine actuator control module 218 may not enable fuel flow in the engine 102 until the turbocharger is at least partially open to allow exhaust flow therethrough.

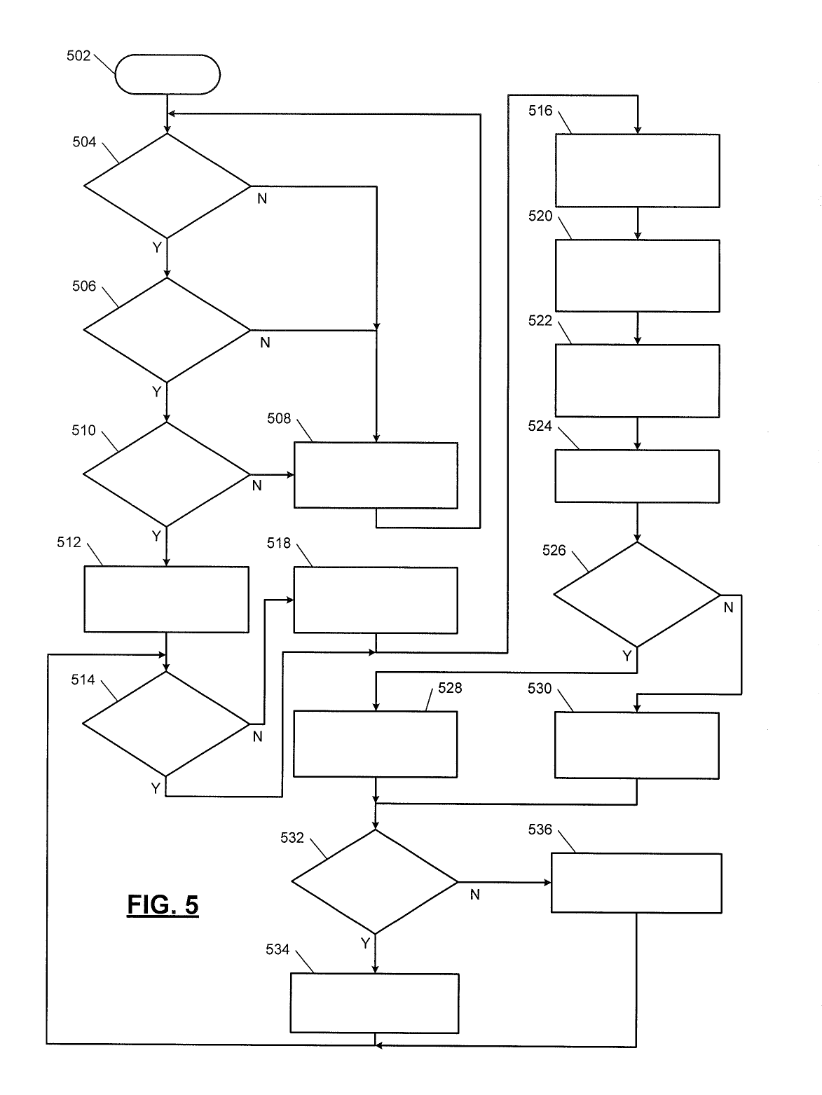

Referring now to FIG. 5, a method for controlling a powertrain system to perform exhaust braking begins at 502. At 504, the method determines whether a driver has selected an exhaust braking mode. The driver may select the exhaust braking mode by pressing a button or a touchscreen or by providing voice commands. If the driver has selected the exhaust braking mode, the method continues at 506. Otherwise, the method continues at 508.

At 506, the method determines whether a transmission is in drive. The method may determine whether the transmission is in drive based on input from a transmission gear selector position sensor. If the transmission is in drive, the method continues at 510. Otherwise, the method continues at 508.

At 510, the method determines whether there are no faults in the transmission or exhaust braking hardware. The exhaust braking hardware may include a variable geometry turbocharger (VGT), a VGT vane position sensor, an exhaust pressure sensor, an exhaust temperature sensor, and/or other hardware components used to effectuate exhaust braking. Examples of methods of detecting faults in a transmission or exhaust braking hardware are discussed above with reference to FIG. 2. If no faults are detected in the transmission or exhaust braking hardware, the method continues at 512. Otherwise, the method continues at 508.

At 508, the method indicates that exhaust braking is not available and/or not enabled. The method may indicate to the driver that exhaust braking is not available and/or not enabled using a visual message (e.g., text), an audible message (e.g., chime), and/or a tactile message (e.g., vibration). The method may indicate to various modules that exhaust braking is not available so that the modules may determine how much powertrain braking torque is available. In various implementations, when the transmission is not in drive, the method may not enable exhaust braking but may still indicate that exhaust braking is available.

At 512, the method indicates that exhaust braking is available and/or enabled. The method may indicate to the driver that exhaust braking is available and/or enabled using a visual message (e.g., text), an audible message (e.g., chime), and/or a tactile message (e.g., vibration). The method may indicate to various modules that exhaust braking is available and/or enabled so that the modules may determine how much powertrain braking torque is available. The method may enable exhaust braking independent of accelerator pedal position before indicating that exhaust braking is enabled.

At 514, the method determines whether engine coolant temperature is within a first temperature range. The first temperature range may be a predetermined temperature range (e.g., greater than 30° C.). The first temperature range may be selected to ensure that the temperature of oil in an engine is sufficient for lubrication and, if an oil-actuated turbocharger is coupled to the engine, for controlling the turbocharger. If the engine coolant temperature is within the first temperature range, the method continues at 516. Otherwise, the method continues at 518.

At 518, the method restricts the amount of exhaust braking torque available. The method may restrict the exhaust braking torque to a level that is inversely proportional to the magnitude by which the engine coolant temperature is outside of the first temperature range. For example, the engine coolant temperature may be outside of the first temperature range when the engine coolant temperature is less than 30° C. Thus, the method may restrict the exhaust braking torque to a lower level when the engine coolant temperature is 10° C. relative to when the engine coolant temperature is 20° C. In addition, the method may not provide exhaust braking when the engine coolant temperature is less than 10° C.

At 516, the method adjusts the powertrain braking torque capacity based on the amount of exhaust braking torque available. The powertrain braking torque capacity may include the amount of braking torque that the engine is capable of producing when fueling to cylinders of the engine is cutoff and the vane position of the turbocharger is adjusted to yield maximum allowable exhaust braking. The powertrain braking torque capacity may also include the amount of negative brake torque that an electric motor is capable of producing at the crankshaft.

At 520, the method adjusts a zero pedal torque based on the powertrain braking torque capacity. The method may request the zero pedal torque when the driver removes their foot from an accelerator pedal or lightly depresses the accelerator pedal, such as when a vehicle is idling or coasting down from a higher speed. Example methods of determining the zero pedal torque are discussed above with reference to FIGS. 2 and 3.

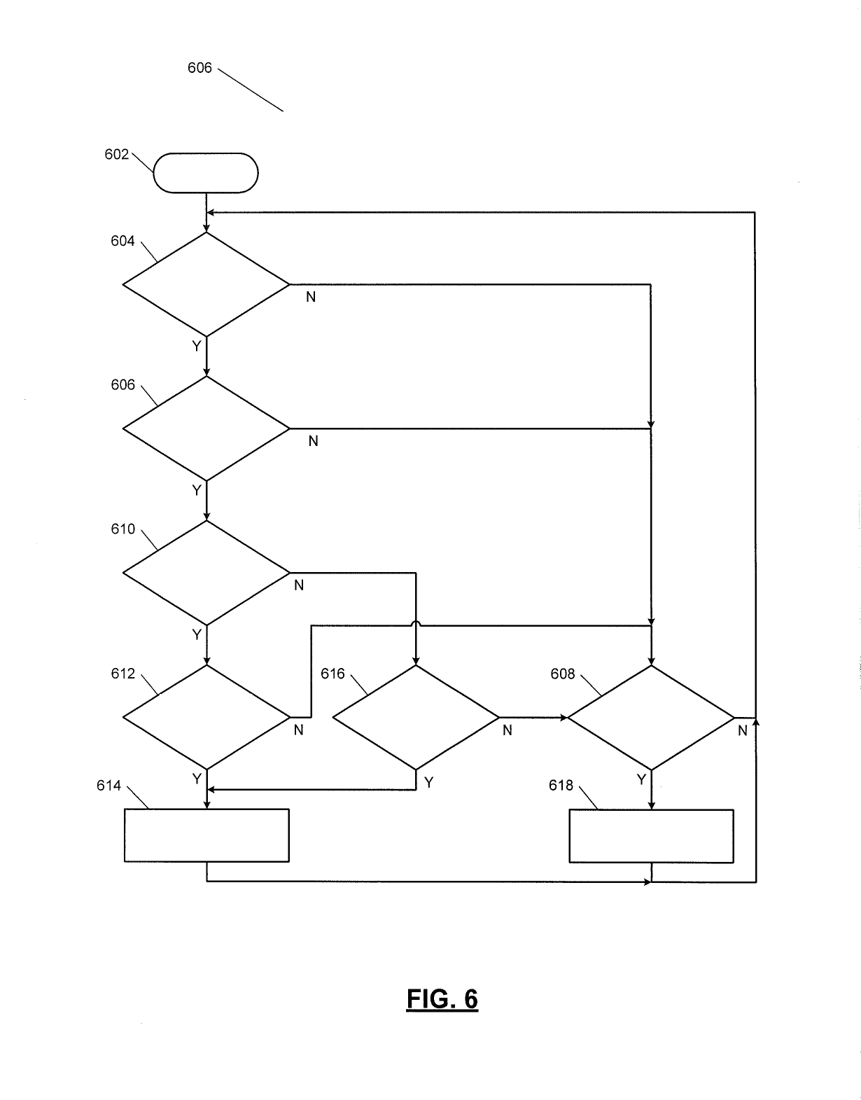

At 522, the method adjusts a transmission shift pattern based on the enablement of exhaust braking and the powertrain braking torque capacity. Example methods of adjusting a transmission shift pattern are discussed above with reference to FIG. 2 and below with reference to FIG. 6. At 524, the method determines a pedal torque request based on the accelerator pedal position. The method may store one or more mappings of accelerator pedal position to torque, and determine the pedal torque request based on a selected one of the mappings.

At 526, the method determines whether the pedal torque request is less than road load. Road load is an amount of torque required to maintain a vehicle speed at a constant speed in nominal conditions (e.g., when the vehicle is travelling on a flat grade). If the pedal torque request is less than road load, the method continues at 528. Otherwise, the method continues at 530. At 530, the method sets the driver torque request equal to the pedal torque request.

At 528, the method adjusts a driver torque request based on the zero pedal torque. If the accelerator pedal position is equal to zero (e.g., the driver's foot is off the accelerator pedal), the method may set the driver torque request to the zero pedal torque. If the accelerator pedal position is greater than zero, the method may set the driver torque request based on accelerator pedal position and a blend between the road load and the zero pedal torque. Example methods of determining the driver torque request in this manner are discussed above with reference to FIG. 4.

At 532, the method determines arbitrates between the driver torque request and other axle torque requests and determines whether the driver torque request wins the arbitration. If the driver torque request is less than decreasing axle torque requests and greater than increasing axle torque requests, the drive torque requests wins the arbitration (the method selects the drive torque request during the arbitration). Otherwise, one of the other axle torque requests wins the arbitration. Axle torque requests may include a stability control request generated by a vehicle stability control system to prevent wheel slip when the coefficient of friction of the road surface is insufficient to support the amount of braking torque produced by exhaust braking. Axle torque requests may also include a transmission shifting torque request to improve the feel of a transmission downshift.

If the driver torque request wins the arbitration, the method continues at 534. Otherwise, the method continues at 536. At 534, the method controls the engine and/or the electric motor based on the driver torque request. At 536, the method controls the engine and/or the electric motor based on the one of the other axle torque requests that wins the arbitration.

Referring now to FIG. 6, a method for adjusting a transmission shift schedule when exhaust braking is enabled begins at 602. At 604, the method determines whether fuel delivery to cylinders of an engine is cutoff. If fuel delivery to the cylinders is cutoff, the method continues at 606. Otherwise, the method continues at 608.

At 606, the method determines whether the torque output of an engine is equal to a maximum braking torque. The engine may produce the maximum braking torque when fueling to the engine is cutoff and a variable geometry turbocharger (VGT) coupled to the engine is adjusted to yield maximum allowable exhaust braking (e.g., a predetermined exhaust braking torque). If the engine torque output is equal to the maximum braking torque, the method continues at 610. Otherwise, the method continues at 608. At 610, the method determines whether cruise control is enabled. If cruise control is enabled, the method continues at 612. Otherwise, the method continues at 616.

At 612, the method determines whether a difference between a vehicle speed and a cruise control set speed is greater than a threshold, which may be predetermined. If the difference between the vehicle speed and the set speed is greater than the threshold, the method continues at 614. Otherwise, the method continues at 608.

At 616, the method determines whether the vehicle speed is increasing. If the vehicle speed is increasing, the method continues at 614. Otherwise, the method continues at 608. At 614, the method requests a transmission downshift. At 608, the method determines whether the current axle torque can be achieved in a higher gear. The method may determine whether the current axle torque can be achieved in a higher gear based on a powertrain braking torque capacity and a gear ratio corresponding to the current gear and a gear ratio corresponding to the higher gear. Example methods of determining whether a current axle torque can be achieved in a higher gear are described above with reference to FIG. 2. If the current axle torque can be achieved in a higher gear, the method continues at 618. Otherwise, the method continues at 604. At 618, the method requests a transmission upshift.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory. Non-limiting examples of a non-transitory tangible computer readable medium include nonvolatile memory, volatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

What is claimed is:

1. A system comprising:
an exhaust braking enabling module that selectively enables exhaust braking based on driver input and independent of an accelerator pedal position;
a driver torque module that selectively determines a driver torque request based on a powertrain braking torque capacity when exhaust braking is enabled; and
an engine actuator control module that controls fuel delivery to cylinders of an engine and a vane position of a turbocharger based on the driver torque request.

2. The system of claim 1 further comprising a zero pedal torque module that determines a zero pedal torque based on the powertrain braking torque capacity, wherein the driver torque module selectively determines the driver torque request based on the zero pedal torque when the accelerator pedal position is greater than zero.

3. The system of claim 2 wherein the driver torque module:
determines a pedal torque request based on the accelerator pedal position; and
determines the driver torque request based on the zero pedal torque when the accelerator pedal position is greater than zero and the pedal torque request is less than a first torque required to prevent a decrease in vehicle speed when traveling on a flat grade.

4. The system of claim 3 wherein the driver torque module sets the driver torque request equal to the pedal torque request when the pedal torque request is greater than or equal to the first torque.

5. The system of claim 1 further comprising an exhaust braking availability module that determines whether exhaust braking is available based on at least one of a transmission state, a transmission fault, an engine coolant temperature, and an exhaust braking hardware fault, wherein the exhaust braking enabling module does not enable exhaust braking when exhaust braking is not available.

6. The system of claim 1 further comprising a braking torque capacity module that determines the powertrain braking torque capacity based on an amount of braking torque produced by the engine when fuel delivery to the cylinders of the engine is cutoff and the vane position of the turbocharger is adjusted to yield a predetermined exhaust braking torque.

7. The system of claim 1 further comprising a transmission control module that adjusts a shift schedule of a transmission when exhaust braking is enabled to increase engine speed and thereby increase a braking torque produced by exhaust braking.

8. The system of claim 7 wherein the transmission control module downshifts the transmission when fuel delivery to the cylinders of the engine is cutoff, the vane position of the turbocharger is adjusted to yield a predetermined exhaust braking torque, and vehicle speed is at least one of increasing and greater than a cruise control set speed.

9. The system of claim 8 wherein the transmission control module:
predicts an axle torque capacity after the transmission is upshifted to a higher gear; and
upshifts the transmission to the higher gear when conditions for downshifting the transmission are not satisfied and a present axle torque is within the predicted axle torque capacity.

10. The system of claim 1 wherein the engine actuator control module stops fuel delivery to the cylinders of the engine when exhaust braking is enabled.

11. A method comprising:
selectively enabling exhaust braking based on driver input and independent of an accelerator pedal position;
selectively determining a driver torque request based on a powertrain braking torque capacity when exhaust braking is enabled; and
controlling fuel delivery to cylinders of an engine and a vane position of a turbocharger based on the driver torque request.

12. The method of claim 11 further comprising:
determining a zero pedal torque based on the powertrain braking torque capacity; and
selectively determining the driver torque request based on the zero pedal torque when the accelerator pedal position is greater than zero.

13. The method of claim 12 further comprising:
determining a pedal torque request based on the accelerator pedal position; and
determining the driver torque request based on the zero pedal torque when the accelerator pedal position is greater than zero and the pedal torque request is less than a first torque required to prevent a decrease in vehicle speed when traveling on a flat grade.

14. The method of claim 13 further comprising setting the driver torque request equal to the pedal torque request when the pedal torque request is greater than or equal to the first torque.

15. The method of claim 11 further comprising:
determining whether exhaust braking is available based on at least one of a transmission state, a transmission fault, an engine coolant temperature, and an exhaust braking hardware fault; and
not enabling exhaust braking when exhaust braking is not available.

16. The method of claim 11 further comprising determining the powertrain braking torque capacity based on an amount of braking torque produced by the engine when fuel delivery to the cylinders of the engine is cutoff and the vane position of the turbocharger is adjusted to yield a predetermined exhaust braking torque.

17. The method of claim 11 further comprising adjusting a shift schedule of a transmission when exhaust braking is enabled to increase engine speed and thereby increase a braking torque produced by exhaust braking.

18. The method of claim 17 further comprising downshifting the transmission when fuel delivery to the cylinders of the engine is cutoff, the vane position of the turbocharger is adjusted to yield a predetermined exhaust braking torque, and vehicle speed is at least one of increasing and greater than a cruise control set speed.

19. The method of claim 18 further comprising:
predicting an axle torque capacity after the transmission is upshifted to a higher gear; and
upshifting the transmission to the higher gear when conditions for downshifting the transmission are not satisfied and a present axle torque is within the predicted axle torque capacity.

20. The method of claim 11 further comprising stopping fuel delivery to the cylinders of the engine when exhaust braking is enabled.
